(19) United States
(12) Patent Application Publication
(10) Pub. No.: US 2018/0126197 A1
(43) Pub. Date: May 10, 2018

(54) Safety Harness With Femoral Vein Protection

(71) Applicant: Marco Einhaus, Wessling (DE)

(72) Inventor: Marco Einhaus, Wessling (DE)

(21) Appl. No.: 15/866,328

(22) Filed: Jan. 9, 2018

Related U.S. Application Data
(62) Division of application No. 12/521,943, filed on Sep. 8, 2009.

(30) Foreign Application Priority Data
Jan. 2, 2007 (DE) 102007001017.8

(51) Int. Cl. A62B 35/00

(52) U.S. Cl. CPC A62B 35/0025

(57) ABSTRACT

Safety harness for the human body, having two leg harnesses for two human legs, wherein at least one of the leg harnesses has an opening which is arranged in such a way as to the keep the vena femoralis at least partially free.

### CROSS-REFERENCE TO RELATED APPLICATION

This application is a divisional application of co-pending U.S. patent application Ser. No. 12/521,943, filed Sep. 8, 2009, which application is a national US phase application of international patent application PCT/EP2008/000002, filed Jan. 2, 2008, which international application claimed the priority of the filing date of German application 102007001017.8, filed on Jan. 2, 2007, the disclosures of which are hereby incorporated herein by reference in their entirety.

### TECHNICAL FIELD

The present invention relates to personal protection equipment against a fall, beyond this relates to all harnesses with support and hanging function, comprising safety harnesses with protection of the femoral vein (Vena formalis) for extending the hanging time until occurrence of the suspension trauma (“Hängetrauma”).

### BACKGROUND

A safety harness is for instance known from US 2005/0045420 A1.This pre-known safety harness comprises a shiftable cushion pad arranged at each of the leg harnesses at the groin region. By the cushion pads, it is intended to reduce the danger of injury which results from a shock absorbing impulse (“Fangstoß”) impacting on the groin region. For an improved adjustment to the groin region, the pre-known cushion pad is centrally equipped with an integral hinge.

### SUMMARY

There may be a need for an improved safety harness, particularly one which influences the blood flow in the groin region in a reduced manner.

This need may be met by the safety harness with the features according to the independent patent claim. Further embodiments are specified in the dependent claims.

By the safety harness according to the invention, the following problem of safety harnesses according to the prior art may be reduced. If a person falls into the protection system with conventional safety harnesses, she/he suffers, according to hitherto existing medical knowledge, in about 20 minutes an orthostatic shock, the so-called suspension trauma (“Hängetrauma”).

The safety harnesses according to the invention can for instance be employed in the following fields: construction, installation, medical and medical technical, parachute, mining, sports climbing, climbing, mobile maintenance platforms, for a silo (“Silobefahranlagen”), rescue, saving (for instance cable railway facilities) or aerospace technology and aerospace suits.

By the novel design of a safety harness with a protection for the femoral vein the hanging time may be significantly increased which is so important for the rescue.

The novel design of the safety harness is characterized in that at least one of the leg harnesses has a recess which is arranged in such a manner that the femoralis vein is at least partially kept free (or maintained uncovered).

The safety harness is positioned in the region of the pelvis for instance by two leg harness pads, made from a compressible material, per side so that an adverse effect on the blood flow of the femoral vein in the groin region from an external influence is prevented. The pads can be made of an identical or a different material.

Due to the anatomy of the human being, the femoral vein is positioned in the central groin region approximately 100 to 200 mm, depending on leg circumference, spaced with regard to the Spina iliaca anterior superior. An ergonomic pad must therefore lead off the harness forces in such a manner via the spinae (iliac spine) and the tuber (tuber ischiadicum) that a sufficiently free back flow to the heart is possible also in a hanging state. For this purpose, the >30 mm thick leg pads are interrupted in the region of the femoral vein over a length of approximately 50 to 150 mm. Particularly, the leg pad has a thickness of 30 mm, preferably 40 mm, particularly preferably 35 mm. The skilled person will select the most appropriate thickness depending on material, field of application and leg circumference. In other words, it has to be ensured that no compression shall occur starting from the femoral vein in both directions for at least 50 mm.

Due to the thus obtained release in the groin region, an only slightly reduced venous blood back flow is enabled which contributes to the significant increase of the hanging time and therefore reduces the mortality rate prior to the rescue. An orthostatic shock occurs according to the here presented product/device with a significant time delay.

### BRIEF DESCRIPTION OF THE DRAWINGS

FIG. 1 shows an exemplary embodiment of a leg harness according to the invention.

FIG. 2 illustrates a further exemplary embodiment of a safety harness according to the invention with leg harness and chest harness.

FIG. 3 illustrates a photo of an exemplary embodiment.

### DETAILED DESCRIPTION

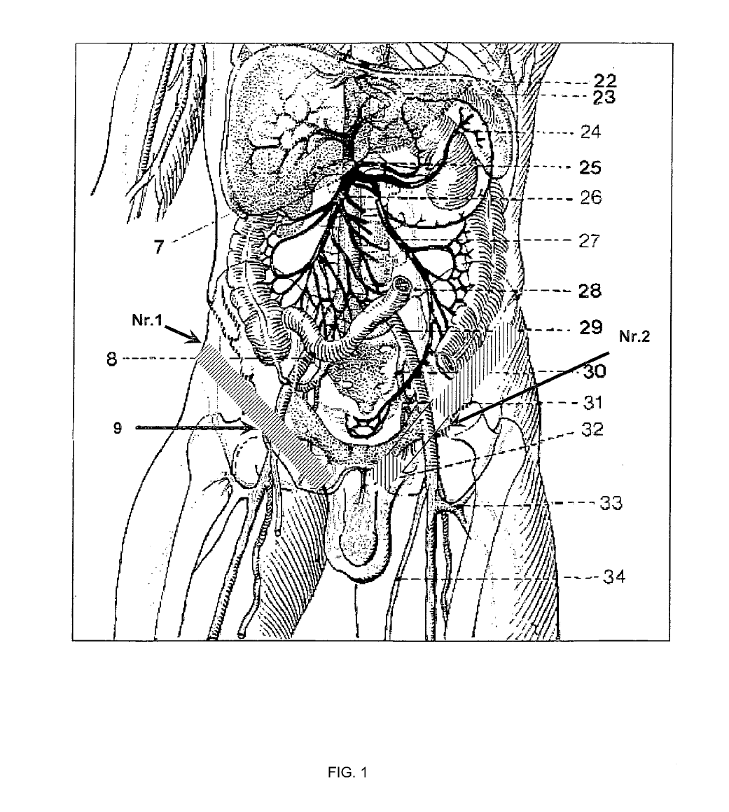

FIG. 1 shows a schematic illustration of an embodiment of a leg harness according to the invention. Particularly, FIG. 1 shows a schematic illustration of a human body with internal organs and the corresponding vein system, wherein the reference numerals 7, 8, 9, 22, 23, 24, 25, 26, 27, 28, 31, 32, 33, and 34 show different organs, veins and arteries. In this connection, the reference numeral 9 denotes the femoral vein. The safety harness for the human body, which safety harness is illustrated in FIG. 1 as hatched areas 1 and 2 comprises two leg harnesses for two human legs, wherein at least one of the leg harnesses has a recess (or an opening) which is located in such a manner that the femoral vein is at least partially kept free. In order to clarify this, the right leg is illustrated in FIG. 1 with a leg harness 1 of a conventional safety harness, whereas the left leg is provided with a leg harness (or leg strap) 2 according to than exemplary embodiment of the invention. In this context, it can be seen that the right leg harness (conventional construction) squeezes the femoral vein 9, whereas the left leg harness according to the invention does not squeeze the femoral vein.

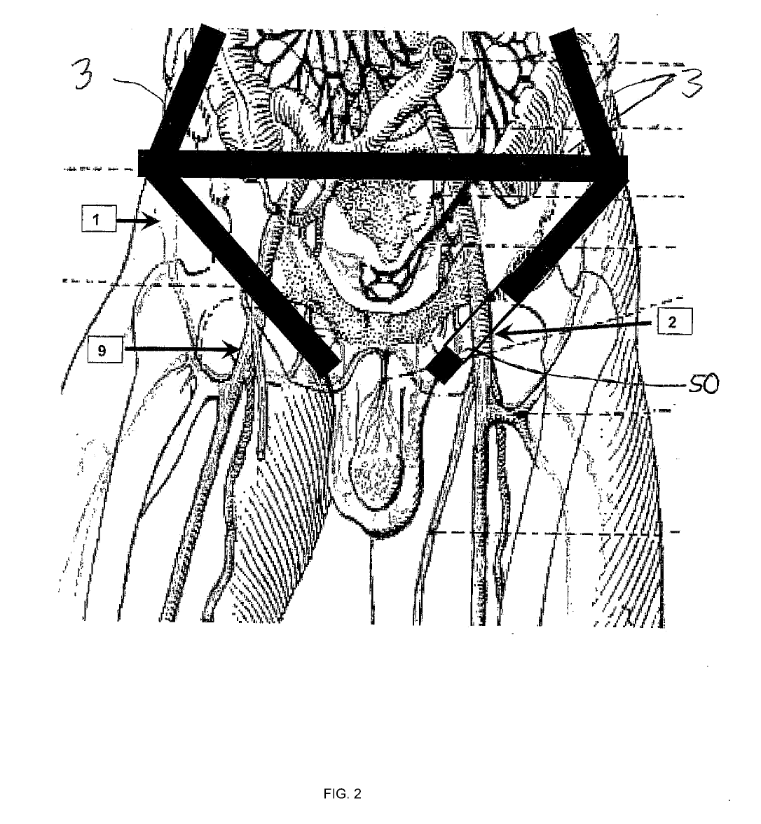

FIG. 2 shows a schematic illustration of a further exemplary embodiment of a safety harness according to the invention with leg harness (or leg strap, “Beingurt”) and chest harness (or chest strap, “Brustgurt”). The basic difference to the embodiments shown in FIG. 1 is that the safety harness additionally comprises a chest harness 3.

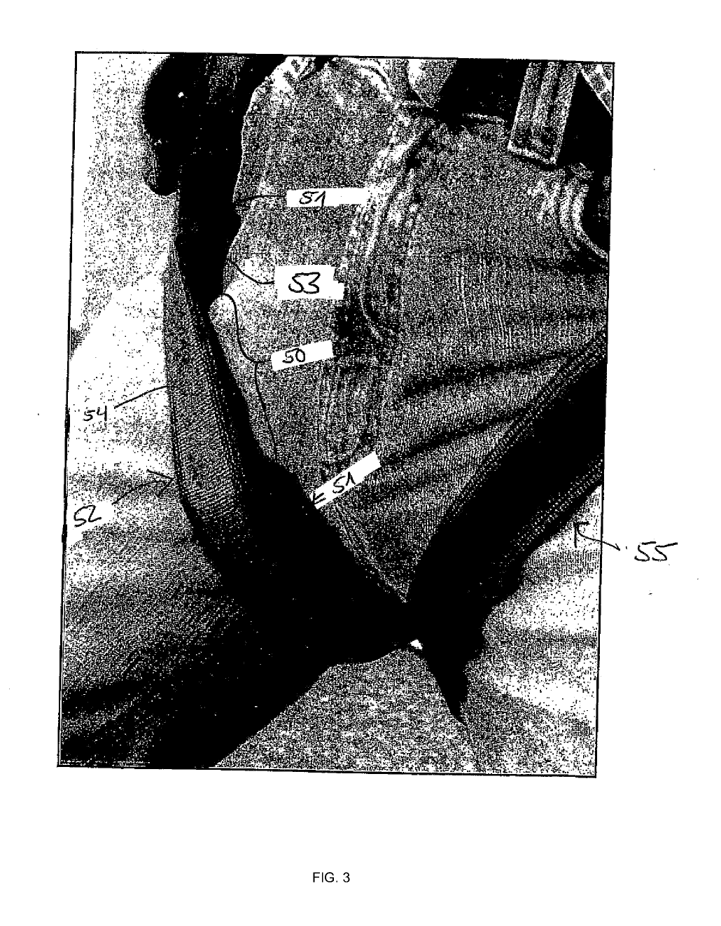

FIG. 3 illustrates a photo of a safety harness at which a recess can be seen at the right leg which recess is formed by two leg pads. A spacing between these two leg pads has the effect that the recess is formed between them which prevents a squeezing of the femoral vein or at least reduces the danger of squeezing.

1. A safety harness for supporting a human body, comprising:
two leg harnesses for two human legs, at least one of the leg harnesses capable of contacting a front portion of a first leg proximal to a crotch of a suspended person and again along an opposed side of a hip joint below a waist of a suspended person,
wherein at least one of the leg harnesses comprises a recess, the recess arranged in such a manner that the recess is capable of keeping a femoral vein of a suspended person at least partially free when the at least one of the leg harnesses is in use,
wherein the at least one of the leg harnesses comprises a pad located along the leg harness such that the pad is proximal to a crotch of a suspended person when the at least one of the leg harnesses is in use,
wherein a material thickness of the pad is adapted to form the recess in such a manner that no compression occurs starting from a portion of the at least one of the leg harnesses that traverses a femoral vein of a suspended person in both directions along the at least one of the leg harnesses for at least 50 millimeters when the at least one of the leg harnesses is in use, the safety harness capable of increasing a hanging time before occurrence of orthostatic shock,
wherein the recess is at least partially filled with gel material.

2. The safety harness according to claim 1, wherein both leg harnesses comprise the recess.

3. The safety harness according to claim 1, wherein the pad consists of rubber foam.

4. The safety harness according to claim 1, wherein the pad consists of plastic.

5. The safety harness according to claim 1, wherein the pad consists of gel material.

6. The safety harness according to claim 1, wherein the recess is configured in such a manner to maintain a blood flow through a femoral vein of a suspended person.

7. The safety harness according to claim 1, wherein the pad comprises a material selected from the group consisting of a gel, rubber foam, and plastic.

8. The safety harness according to claim 1, wherein the recess is applied in an aerospace field.

9. The safety harness according to claim 1, wherein the recess is applied in a medical field.

10. The safety harness according to claim 1, wherein the recess is applied to one of a parachute harness, a climbing harness, a work harness, and a rescue harness.

11. The safety harness according to claim 1, wherein the pad has a thickness in an uncompressed state of greater than 30 millimeters.

12. The safety harness according to claim 1, wherein the recess is formed by a first pad and a second pad, wherein the first pad is separate from the second pad.

13. The safety harness according to claim 12, wherein the recess defines a gap of approximately 50 to 150 millimeters.

14. A safety harness for arresting a fall of a person and increasing the time that a person can safely remain suspended by the safety harness without suffering from orthostatic shock, the safety harness comprising:
a first leg harness comprising an inner surface and an opposed outer surface and arranged such that the inner surface is capable of contacting a front portion of a first leg proximal to a crotch of a suspended person and again on an opposed side of a hip joint below a waist of a suspended person, wherein the inner surface includes a recess,
wherein the first leg harness comprises opposing pads located along the first leg harness such that the opposing pads are proximal to a crotch of a suspended person when the first leg harness is in use,
wherein a material thickness of the opposing pads is adapted to form the recess in such a manner that no compression occurs starting from that portion of the first leg harness that traverses a femoral vein of a suspended person in both directions along the first leg harness for at least 50 millimeters when the first leg harness is in use,
wherein the opposing pads are made from different compressible materials.

15. The safety harness of claim 14, further comprising:
a second leg harness comprising an inner surface and an opposed outer surface and arranged such that the inner surface is capable of contacting a front portion of a second leg of a suspended person and again on an opposed side of a hip joint of a suspended person, wherein the inner surface includes a respective recess.

16. The safety harness of claim 14, wherein the opposing pads comprise a material selected from the group consisting of a gel, rubber foam, and plastic.

17. The safety harness of claim 14, wherein a material thickness of the opposing pads is different.

18. The safety harness of claim 17, wherein the opposing pads have a thickness in an uncompressed state of greater than 30 millimeters.

19. The safety harness of claim 14, wherein a material thickness of the opposing pads is the same.

20. The safety harness of claim 14, wherein the opposing pads form a gap of approximately 50 to 150 millimeters.
